(19) United States
(12) Patent Application Publication
(10) Pub. No.: US 2011/0161121 A1
(43) Pub. Date: Jun. 30, 2011

(54) Method, System, and Article for Management of Travel

(75) Inventors: Abhinay R. Nagpal, Maharashtra (IN); Sandeep Ramesh Patil, Somers (IN); Dhaval K. Shah, Gujarat (IN); Yan W. Stein, San Jose, CA (US)

(73) Assignee: INTERNATIONAL BUSINESS MACHINES CORPORATION, Armonk, NY (US)

(21) Appl. No.: 12/647,421

(22) Filed: Dec. 25, 2009

(51) Int. Cl. G06Q 10/00

(52) U.S. Cl. 705/5

(57) ABSTRACT

A method, system, and article for management of travel and travel related matters. Both a source and a designation are selected, together with the associated departure and arrival information and the mode of transportation. A geographic region affected by a health related event is identified, and then employed to determine if a craft in support of the selected travel has been or is intended to be in the identified region. Exposure to the identified health related event may be mitigated by supporting an amendment to the mode of transportation.

### BACKGROUND

1. Technical Field

This relates to management of travel and travel related itineraries. More specifically, this relates to assessing and mitigating exposure to one or more identified illnesses based upon proximity evaluation.

2. Description of the Prior Art

Prior to modern forms of travel that enable people to cross international borders on a daily basis, travelers were frequently evaluated for illness and exposure to illness upon arrival at a port of entry. Travelers who exhibited signs of an illness were not always allowed entry from the port and at times were sent back to their point of origin. Sometimes the travelers who exhibited signs of illness or who were known to have been exposed to an illness were placed in quarantine for a period of time.

With the advent of modern forms of travel and communication, and the open borders that exist in many countries, localizing an illness and people who have been exposed to an illness can be difficult and challenging. In a strictly controlled environment, there is the ability to evaluate the health and wellness of all travelers. However, this can be a difficult task to implement. If a gap is present in the evaluation process, then the evaluation is incomplete. At the same time, there is the possibility that some travelers may have been exposed to an illness without exhibiting any symptoms. Perhaps such travelers are merely carriers of the illness. Accordingly, known methods for isolating travelers is both difficult and cumbersome.

There are two aspects to address exposure to an illness. One aspect is to confine the illness and mitigate its effect. Another aspect is to manage travel arrangements to avoid and/or mitigate exposure to the illness. Accordingly, there is a need to employ a tool to morph information pertaining to one or more illnesses with technology employed for management of travel, in order to reduce exposure of a traveler to the illness(es).

### SUMMARY

A method, system, and article are provided for management of travel and travel related plans in view of health care concerns.

In one aspect, a computer implemented method is provided for travel management. Both a source and a destination are selected for the travel, with the source and destination including departure and arrival dates, and a mode of transportation that supports the selected source and destination. Following the selection processes, a geographic region that has been affected by a health related event is identified. Based upon the health related event, the selected mode of transportation is evaluated to determine if at least one craft that supports the selected transportation mode matches the geographic region affected by the health related event. To mitigate exposure to the identified health related event, the selected transportation mode may be changed. Accordingly, a reservation is created that supports the selected travel based upon an evaluation of both the mode of transportation and the identified health related event.

In another aspect, a system is provided to facilitate management of travel. A processor is provided in communication with a data storage medium, and a management tool is provided in communication with the data storage medium. The management tool includes a selection module, to select a source and destination for travel, and a mode of transportation to support the selected source and destination. In addition, both an identification module and an evaluation module are provided. The identification module identifies a geographic region affected by a health related event, and the evaluation mode, which is in communication with both the selection and identification modules, determines if at least one method of transportation within the selected transportation mode(s) matches the identified geographic region. A manager in communication with the evaluation modules mitigates exposure to the health related event by supporting a change to the selected mode of transportation. Accordingly, a reservation is created that supports the selected travel based upon both the evaluation of the mode of transportation together with the identified health related event.

In yet another aspect, an article is configured to manage travel. The article is provided with a computer readable storage medium in communication with computer program instructions to collect and evaluate travel related data. The instructions support selection of both source and destinations for travel, including departure and arrival dates, and selection of a mode of transportation to support the selection. In addition, instructions are provided to support identification of a geographic area affected by a health related event. Instructions are also provided to support evaluation of the selected transportation mode and to mitigate exposure to the health related event. Based upon the instructions, a reservation is provided to support the selected travel based upon both the evaluation of the mode of transportation and with the identified health related event.

Other features and advantages will become apparent from the following detailed description of the presently preferred embodiment, taken in conjunction with the accompanying drawings.

### BRIEF DESCRIPTION OF THE DRAWINGS

The drawings referenced herein form a part of the specification. Features shown in the drawing are meant as illustrative of only some embodiments, and not of all embodiments unless otherwise explicitly indicated. Implications to the contrary are otherwise not to be made.

FIG. 1 is a flow chart illustrating the process of booking travel plans that incorporate health care concerns according to the preferred embodiment, and is suggested for printing on the first page of the issued patent.

FIG. 2 is a flow chart illustrating the process for evaluating one or more crafts employed to complete travel in support of an itinerary.

FIGS. 3A and 3B are a flow chart illustrating seat selection in view of communicable illnesses and the travel history of fellow passengers scheduled for a selected craft.

FIG. 4 is a flow chart illustrating process for evaluating the source of the food and drink supply for the craft and whether it originates in or has been in a geographic region affect by a health related event.

FIG. 5 is a diagram illustrating a computer system with one or more modules to facilitate management of travel arrangements.

### DESCRIPTION OF THE PREFERRED EMBODIMENT

It will be readily understood that the components, as generally described and illustrated in the Figures herein, may be arranged and designed in a wide variety of different configurations. Thus, the following detailed description of the embodiments of the apparatus, system, and method, as presented in the Figures, is not intended to limit the scope, as claimed, but is merely representative of selected embodiments.

The functional units described in this specification have been labeled as tools, modules, and/or managers. The functional units may be implemented in programmable hardware devices such as field programmable gate arrays, programmable array logic, programmable logic devices, or the like. The functional units may also be implemented in software for execution by various types of processors. An identified functional unit of executable code may, for instance, comprise one or more physical or logical blocks of computer instructions which may, for instance, be organized as an object, procedure, function, or other construct. Nevertheless, the executables of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification is not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments. One skilled in the relevant art will recognize, however, that the described features, structure, or characteristics can be practiced without one or more of the specific details, or with other methods, components, materials, etc. In other instances, well-known structures, materials, or operations are not shown or described in detail to avoid obscuring aspects.

The illustrated embodiments will be best understood by reference to the drawings, wherein like parts are designated by like numerals throughout. The following description is intended only by way of example, and simply illustrates certain selected embodiments of devices, systems, and processes that are consistent with the claims presented herein.

### Overview

A method and system are provided to address safety concerns for travelers, and more specifically safety focused on mitigated exposure of travelers to illnesses. When travelers book travel plans they are provided with information on current identified illnesses. This information is incorporated into their travel booking so that they may amend and/or cancel their travel plans in order to mitigate or avoid exposure to the identified illness(es). A smart system is incorporated into a plurality of aspects of the travel booking process to identify crafts, locations, and other travelers that may have been exposed to the identified illness(s). Accordingly, based upon the smart system identification, the person(s) booking the travel may amend and/or cancel one or more aspects of their travel plans in order to avoid exposure to the identified illness(es).

### Technical Details

In the following description of the embodiments, reference is made to the accompanying drawings that form a part hereof, and which shows by way of illustration the specific embodiment in which the method, apparatus, system, and/or article of manufacture may be practiced. It is to be understood that other embodiments may be utilized because structural changes may be made without departing from the scope.

The level of detail in booking travel plans vary among different travel planning systems. More specifically, travel arrangements may be implemented on a level that merely includes a place of origin, a destination, and a mode of travel. It is common for the travel arrangements to include the specifics of the carrier to support the travel. Most carriers today identify a specific craft and enable seat selection. The specificity of details for the travel provides a window for tools to leverage the associated information to support safer travel to mitigate the spread of or exposure to contagious illnesses.

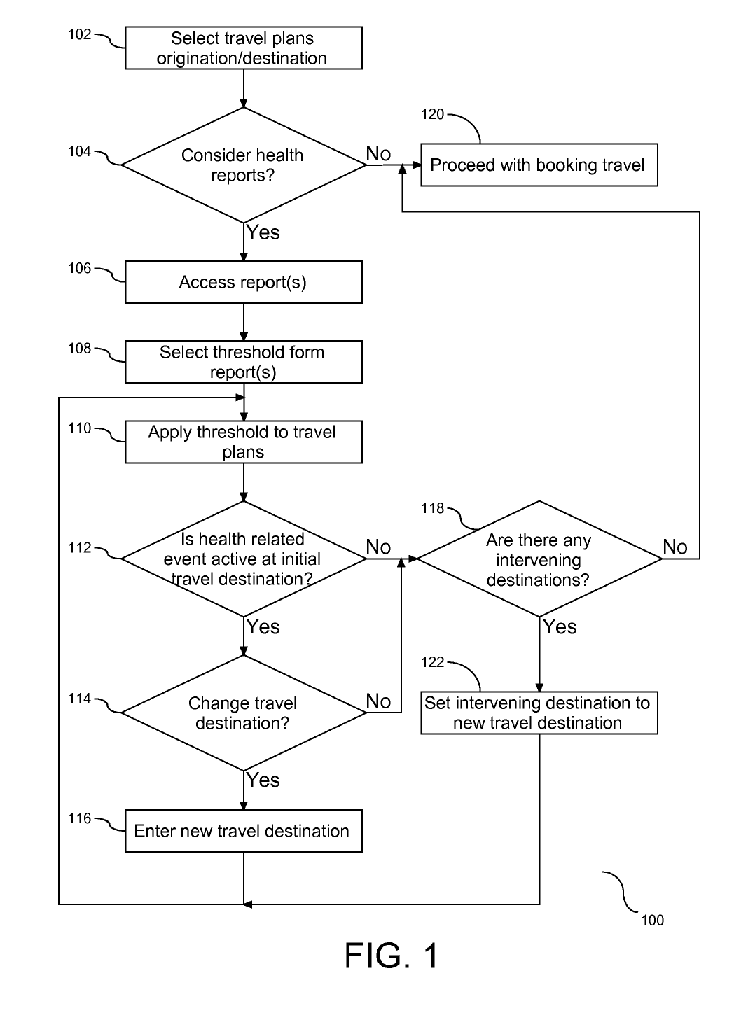

FIG. 1 is a flow chart (100) illustrating the process of booking travel plans that incorporate health care concerns. Initially, the points of travel are selected (102). Each component of a trip has a place of origin and a destination location, and both the places of origin and destination are selected at step (102). Once the selection is completed, it is determined if the traveler is concerned with current health care issues, and as such if they want parse their travel itinerary based upon current and identifiable health care issues (104). There are different organization and government agencies that monitor the spread of diseases in different parts of the world. One example of a health care monitoring agency is the World Health Organization (WHO). These government agencies are known to track and monitor the spread of communicable illnesses, and to produce information demonstrating areas around the world and how such areas may be affected by or exposed to an identified illness. In one embodiment, the information produced is organized into one or more reports. A negative response to the determination at step (104) will allow the traveler to proceed with their travel planning without considering health care issues (120). However, a positive response to the determination at step (104) will provide the traveler with access to one or more health care reports (106). In one embodiment, the traveler may access a health report provided by the WHO. Similarly, in another embodiment, the traveler may access a health report provided by a government, a private office, or another source. Accordingly, one or more sources of health information may be accessed and applied to the travel plans.

Following step (106), the traveler selects or otherwise communicates a threshold level (108) to apply from the health related event to their travel plans (110). In one embodiment, information pertaining to the health related event may contain a scale pertaining to the level of an associated illness, and the traveler may set a threshold value to apply to the scale to determine whether or not the presence of the associated illness will affect their travel. Once the threshold is applied to the travel itinerary, it is determined if the threshold level of the associated illness is active at the initial travel destination (112). A positive response to the determination at step (112) is followed by determining whether or not the traveler wants to change their initial travel destination (114). A positive response to the determination at step (114) is followed by the traveler providing a new initial travel destination (116) and a return to step (110). Conversely a negative response to the determinations at either step (112) or (114) is followed by determining if there are any intervening destinations in the travel plans (118). A positive response to the determination at step (118) is followed by setting an intervening destination as the new travel destination (122) and a return to step (110). Conversely, a negative response to the determination at step (118) is followed by a return to step (120). Accordingly, each destination in the travel plans may be evaluated with the threshold level set and applied to the travel itinerary.

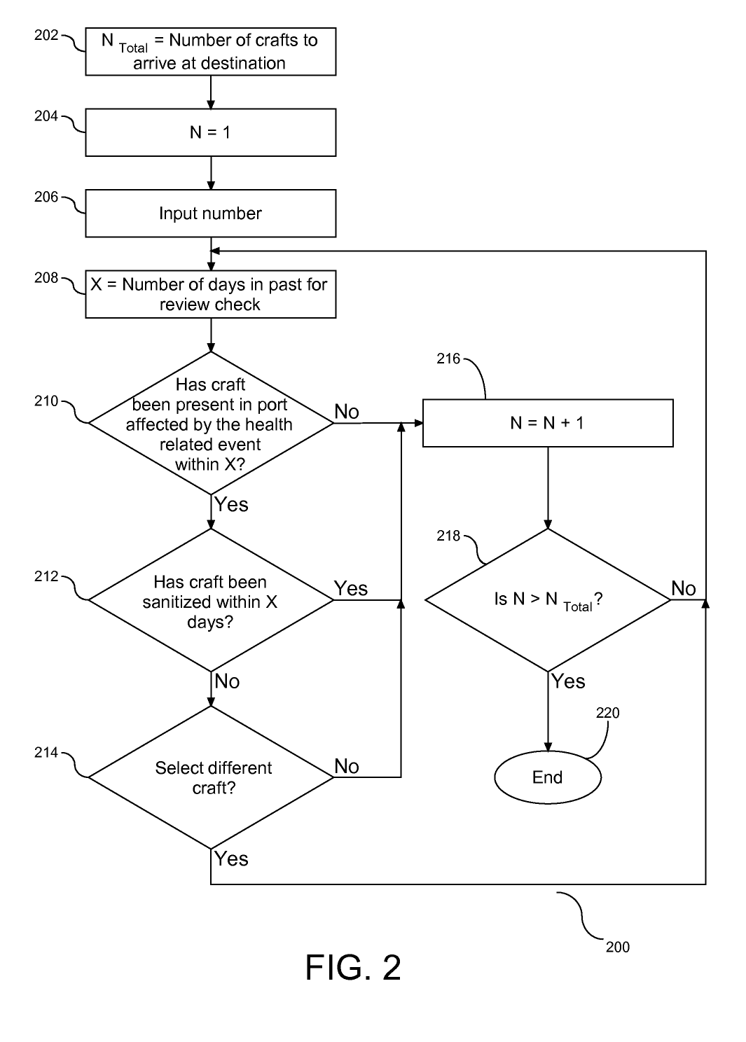

All travelers employ some form of transportation to travel from a place of origin to a destination. Examples of forms of transportation include, but are not limited to, aircraft, watercraft, train, bus, automobile, etc. Hereinafter, the term craft will be employed as a generic term for the form of transportation selected to support a travel itinerary. FIG. 2 is a flow chart (200) illustrating the process for evaluating one or more crafts employed to complete the travel in support of the itinerary. Once the itinerary is established, the variable N_{Total} is set to the number of crafts employed from the point of origin to the final destination (202), and the counting variable N is set to the integer one (204). Each craft employed to support the itinerary may be reviewed to determine the draft's exposure to a health related event. In other words, the craft or items or persons on the draft may carry or contain spores that carry the illness. This information is conveyed to the traveler so that they can make an educated decision about whether or not they wish to utilize this craft to complete their travel, if they will seek a craft from a different location, or possibly cancel their plans altogether. The traveler may input the number of days in the past for reviewing the history of the craft (206), and the variable X is assigned to the number of days provided by the traveler (208). It is then determined if the craft has been in a location affected by the identified health related event within the parameter identified by the variable X (210). A positive response to the determination at step (210) is followed by a subsequent determination to assess whether the craft has been sanitized within the parameter identified by the variable X (212). A negative response to the determination at step (212) is followed by an option to select a different craft to support the travel plans (214). A positive response to the determination at step (214) is followed by a return to step (208). Conversely, a negative response to the determinations at steps (210) or (214) or a positive response to the determination at step (212) is followed by an increment of the variable N (216). It is then determined if all of the crafts employed to support the travel from the point of origin to the destination have been evaluated (218). A negative response to the determination at step (218) is followed by a return to step (208). Conversely, a positive response to the determination at step (218) concludes the evaluation of the crafts (220). Accordingly, as demonstrated herein, each craft employed to support the travel itinerary may be evaluated for exposure to the identified illness and the likelihood that the illness may be present on the craft.

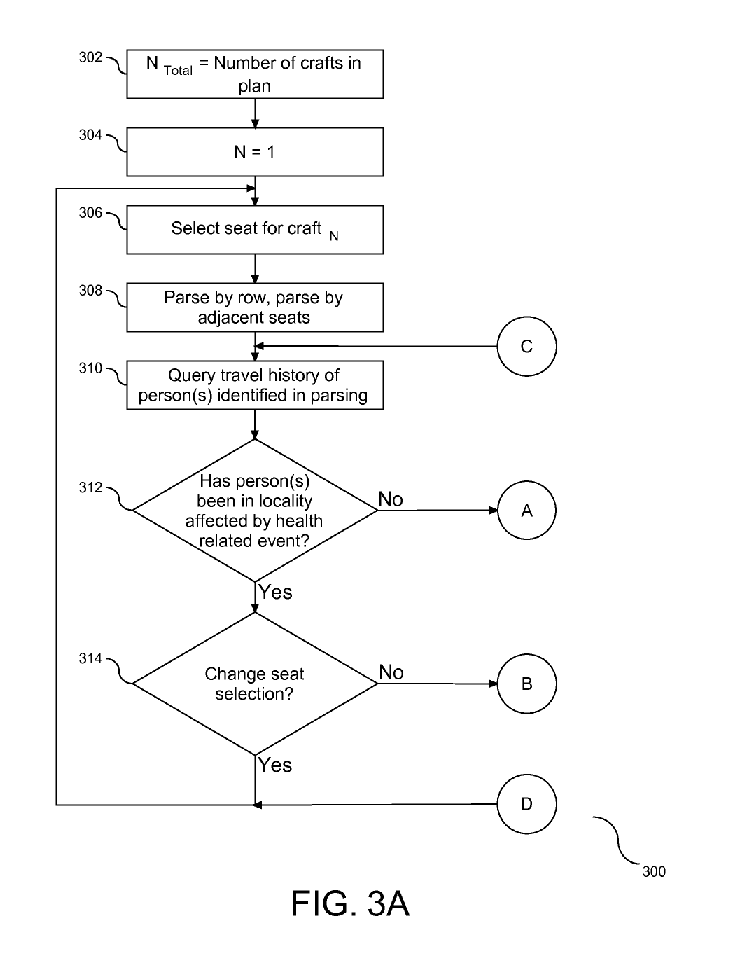

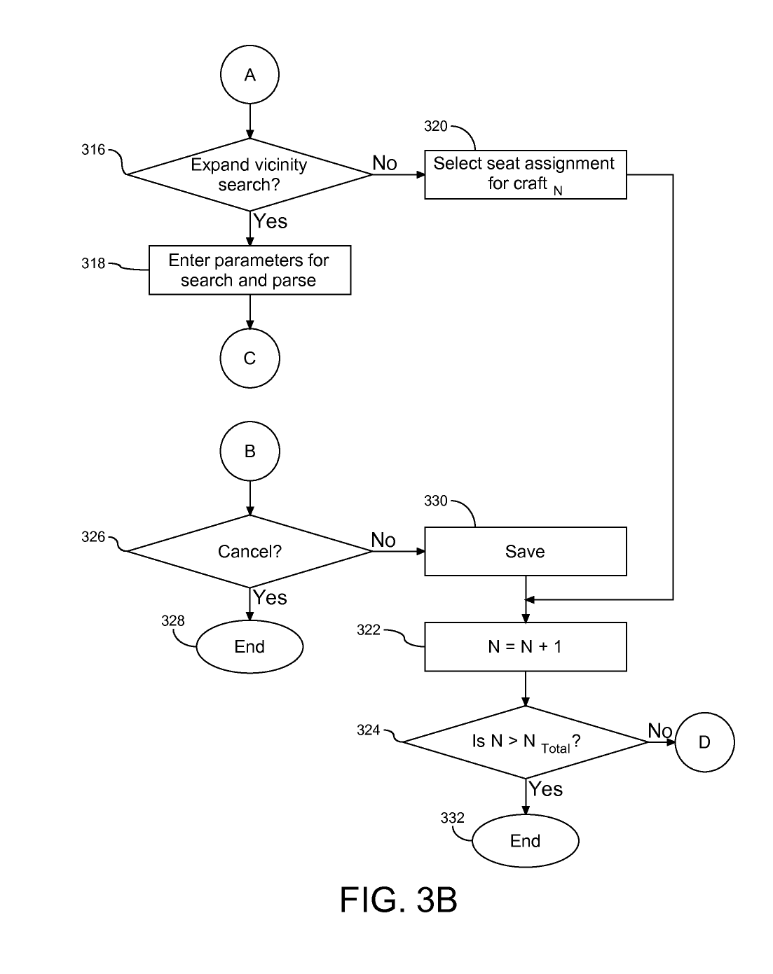

In addition to, or independent of the craft review, the traveler may select a seat assignment on the selected craft based upon other travelers who have travel booked on the same craft. More specifically, the traveler may evaluate the travel health history of other travelers to determine seat selection and next to whom they are willing to be seated for their time on the selected craft. In one embodiment, the travel health history of travelers is an assessment of locations where other passengers have traveled and a likelihood of these other travelers having been exposed to an identified illness based upon the geographic regions where the traveler(s) has been. FIGS. 3A and 3B are a flow chart (300) illustrating the process for seat selection in view of communicable illnesses and the travel history of fellow passengers scheduled for the selected craft. Initially, the variable N_{Total} is assigned to the number of crafts selected to support the travel itinerary (302), and the counting variable N is assigned to the integer one (304). The traveler then selects a seat for craft_{N} (306). To logically assess the travel history of other passengers, the traveler parses the craft based upon the proximity of other scheduled passengers to the row of the selected seat (308). The travel history of each person assigned to a seat identified in the parsing is queried (310). It is then determined if each person identified has been in a jurisdiction affected by the identified illness (312). A positive response to the determination at step (312) is followed by a subsequent determination to allow the traveler to change their seat selection (314). A positive response to the determination at step (314) is followed by a return to step (306). However, a negative response to the determination at step (312) is followed by a query to determine whether the traveler would like to expand the perimeter from the selected seat in order to assess the travel history of additional passengers (316). A positive response to the determination at step (316) is followed by the traveler entering the parameters for the expanded perimeter search and parsing the perimeter data to gather identification information for the passengers that fall within the expanded perimeter (318). Upon completion of the searching and parsing at step (318), the process returns to step (310) for further evaluation. Conversely, a negative response to the determination at step (316) is an indication that the passenger is comfortable with their seat assignment, and the reservation of the seat assignment for the identified craft is completed (320). From another perspective, a negative response to the determination at step (314) is an indication that the traveler has evaluated the health history of other passengers on the craft and has decided not to change their seat selection. The traveler is then provided the option of whether or not to cancel their reservation for the craft (326). A positive response to the determination at step (326) ends the seat selection process (328). Conversely, a negative response to the determination at step (326) is followed by saving the seat selection (330), an increment of the variable N (322), and an assessment of whether there are other crafts identified in the travel plan (324). If there are additional crafts, the process returns to step (306), and if there are no additional crafts, the process of seat selection is completed (332). Accordingly, the process of seat selection enables the traveler to assess the travel health history of other passengers who have selected the same craft for the same trip.

As shown in FIGS. 3A and 3B, the seat assessment is based upon reservations of other passengers that have been made. However, in one embodiment, there may be empty seats at the time of the seat selection and review process. These empty seats cannot be evaluated in the same manner as a seat with a reservation. However, in one embodiment, the traveler may receive a notification when a previously empty seat within a vicinity of the traveler's seat receives a reservation. Following receipt of the notification, the traveler may proceed to step (310) of FIGS. 3A and 3B to assess whether or not the traveler wants to amend or cancel their seat selection.

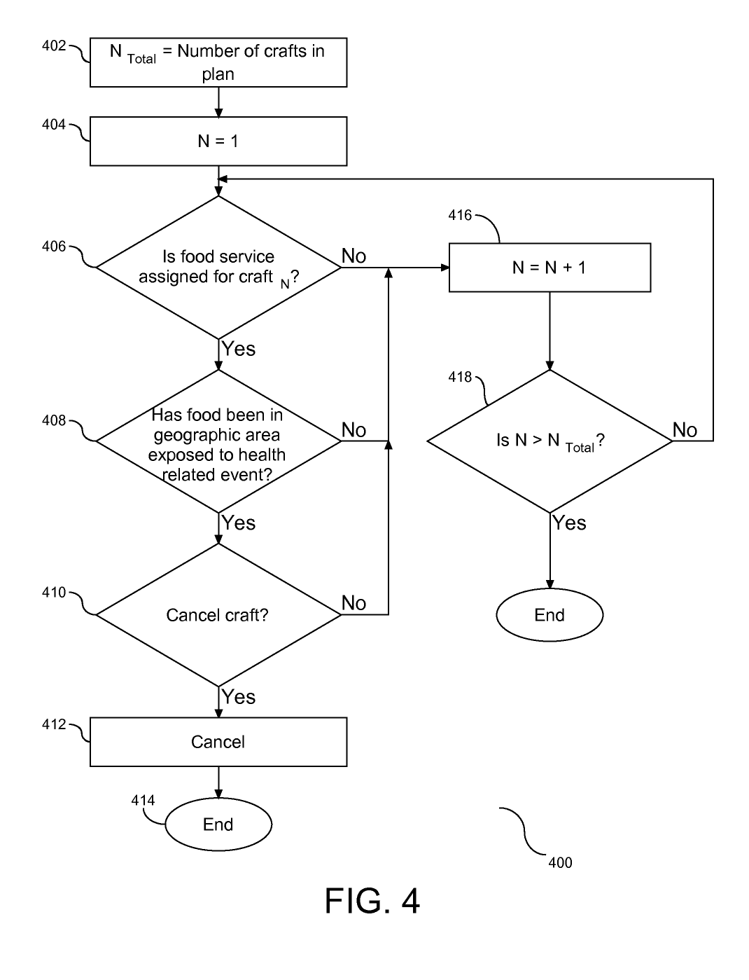

The exposure to a health related event or infectious illness is not limited to the craft or the passengers, it may also be in the food and drink supply. Geographic regions that have been exposed to a health related event may have traces of the illness in their supply of food and drink. Although not all forms of travel include food service, many do include drink service. FIG. 4 is a flow chart (400) illustrating a process for evaluating the source of the food and drink supply for the craft and whether it originates in or has been in a geographic region affect by a health related event as identified by a reliable health source. Initially, the number of crafts required to complete the planned travel is identified and assigned to the variable N_{Total} (402), and a counting variable N is assigned to the integer one (404). It is then determined if food service is indicated for the craft (406). In one embodiment, the food service can include delivery of food and/or drink. For food and drink it is important to determine their point of origin to assess potential exposure and contamination with any identified health related event. A positive response to the determination at step (406) is followed by assessing if the food to be supplied to the craft has been in or may originate from a geographic region identified as affected by the health related event (408). A positive response to the determination at step (408) is followed by allowing the traveler the option to cancel their reservation on the craft (410). In one embodiment, the traveler may opt to maintain their reservation and to bring on the craft all of their own food and drink. If the traveler selects the option to cancel their reservation (412), the process of assessing the origination of food and/or drink is completed (414). Conversely, a negative response to the determinations at any of steps (406), (408), or (410) is an indication that regardless of the food and/or drink assessment, the traveler will continue with their travel plans. Thereafter, the variable N is incremented (416), followed by determining if there are additional crafts for completion of the itinerary (418). If it is determined there are more crafts, the process returns to step (406) for further assessment and evaluation. Conversely, if it is determined that there are no more crafts, the food and/or drink assessment and evaluation is completed (414). Accordingly, for each craft employed for completion of the travel, it is determined if food and/or drink service is available, and if so, the potential exposure of the food and/or drink to any identified illnesses.

In one embodiment, the travel management tool(s) is implemented in software, which includes but is not limited to firmware, resident software, microcode, etc. This implementation can take the form of a computer program product accessible from a computer-usable or computer-readable medium providing program code for use by or in connection with a computer or any instruction execution system. It is also understood, that the computer program may be accessible across a distributed network of computers. For the purposes of this description, a computer-usable or computer readable medium can be any apparatus that can contain, store, communicate, or transport the program for use by or in connection with the instruction execution system, apparatus, or device.

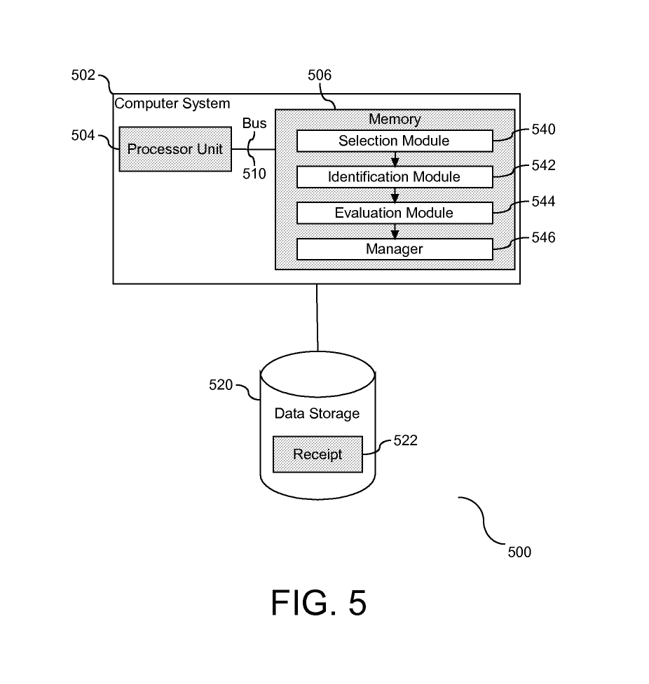

FIG. 5 is a block diagram (500) illustrating a computer system with one or more modules to facilitate management of travel arrangements. The illustration shows a computer system (502) with a processor unit (504) coupled to memory (506) by a bus structure (510). Although only one processor unit is shown, in one embodiment, the computer system (502) may include more processor units in an expanded design. The computer system (502) is in communication with data storage (520). One or more tools are employed to support the intelligent travel planning system. A selection module (540) is provided local memory (506) and in communication with the processor unit (504). The selection module (540) provides the functionality for selection of both the source and destination for the intended travel. In addition, the selection tool enables selection of departure and arrival dates, as well as selection of a mode of transportation to support the travel. In one embodiment, the travel may use a craft in the form of a car, a train, a watercraft, or an airplane. For example, for travel in the form of a cruise vacation, the traveler may require a reservation on an airplane, followed by land transportation to the watercraft. Each of the land vehicle, airplane, and water craft utilize separate modes of transportation. To enable intelligent planning of the travel, an identification module (542) is provided in communication with the selection module (540). The identification module functions to identify the geographic regions where the traveler will be entering, and tracks the spread of health related events around the world. More specifically, once the health related event has been identified, the identification module (542) may ascertain if any of the geographic regions of the intended travel are identified as areas that have had an exposure to the health related event(s). Accordingly, the selection module (540) together with the identification module (542) functions to gather and assess data pertaining to a travel itinerary.

The intelligent travel planning involves more than identifying the location of an identified contagious illness. In fact, the intelligent travel planning enables the traveler to parse information and determine their risk factors associated with the travel. An evaluation module (544) is provided in communication with both the selection and identification modules (540) and (542), respectively. The evaluation module (544) functions to determine if there is a match between at least one of the crafts selected for the intended travel and at least one region identified as exposed to a health related event. If the evaluation module (544) determines there is no match, then the traveler may proceed with completion of their travel itinerary in view of health care concerns. However, in the event there is a match, a manager (550) is provided in communication with the evaluation module (544), wherein the manager enables and otherwise supports a change of the travel itinerary to mitigate exposure to the identified health related event. There are different forms of travel evaluation, including but not limited to, modifying the destination(s), evaluation of the craft(s), seat selection for the craft(s), and food service. Once the travel arrangements are completed, one or more reservations are generated. In one embodiment, reservations are in the form of an electronic communication and or receipt (522) retained in data storage (520). Similarly, in another embodiment, a hardcopy of the reservation (not shown) is created. Accordingly, an intelligent travel planning tool is provided that enables the travel to make smart decisions to mitigate exposure to an identified health related event.

As shown herein, the travel management tools in the formations of a selection module (540), an identification module (542), an evaluation module (544), and a manager (546) each reside in memory (506) local to the system (502). In one embodiment, the system (502) may be accessed locally from a terminal in direct communication with the processor and the supported tools, or it may be accessed from a remote location from a machine in communication with the processor and the supported tools. Similarly, in one embodiment, the selection module (540), the identification module (542), the evaluation module (544), and the manager (546) may each reside as hardware tools external to memory (506), or they may be implemented as a combination of hardware and software. Similarly, in one embodiment, the modules (540), (542), (544), and the manager (546) may be combined into a single functional item that incorporates the functionality of the separate items. Furthermore, as shown herein, each of the modules (540), (542), (544), and the manager (546) are local to one system (502). However, in one embodiment, they may be collectively or individually distributed across a network and function as a unit to embody the functionality of individual units. Accordingly, the modules (540), (542), and (544), and manager (546) may be implemented as software tools, hardware tools, or a combination of software and hardware tools for managing the functionality of the planner in a distributed manner.

Embodiments within the scope also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over the Prior Art

The tools provided for management of travel and travel related plans support an intelligent travel management system to mitigate the spread of an identified health related event. Travel arrangements may be modified on a micro or macro scale based upon the presence of the identified health related event(s). More specifically, it is the level of awareness and spread of the health related event(s) that supports greater control over travel arrangements. Adaptation of travel arrangement modifications leads to optimal travel accommodations and more accurate control of the spread of an illness caused by modern travel. More specifically, craft, seat selection, and food service are each individual selected and/or modified based upon recent travel history of the craft, other passenger, and food supply for the food service. Accordingly, a manner of finely tuning travel plans to mitigate exposure to a health related event is taught herein.

### Alternative Embodiments

It will be appreciated that, although specific embodiments have been described herein for purposes of illustration, various modifications may be made without departing from the spirit and scope. In particular, the specific application disclosed herein is for controlling travel arrangements, and more specifically mitigating exposure to an identified illness during travel. In one embodiment, the travel arrangements may be modified subsequent to booking the travel and prior to departure, based upon an awareness of the health related event that was previously unknown. More specifically, if the health related event is identified at any time prior to actual travel, the traveler may be notified and provided the option to modify and/or cancel the destination, craft, seat assignment, and food service. Furthermore, in one embodiment, the health related event may be any form of a sickness, including but not limited to a virus, a bacterial infection, or combinations thereof. Accordingly, the scope of protection is limited only by the following claims and their equivalents.

We claim:

1. A computer implemented method for travel management, comprising:
selecting a source and destination for travel, including departure and arrival dates;
selecting a mode of transportation to support the selected source and destination travel;
identifying a geographic area affected by a health related event;
evaluating the selected mode of transportation to determine if at least one craft supporting the selected mode of transportation matches the identified geographic area affected by the identified health related event;
mitigating exposure to the identified health related event, including supporting a change to the selected mode of transportation if the transportation matches the identified geographic area affected; and
a reservation to support the selected travel based upon evaluation of the mode of transportation and with the identified health related event.

2. The method of claim 1, wherein the step of evaluating the select mode of transportation further comprises evaluating at least one recent destination port for the selected craft and determining exposure of the craft to the identified health related event.

3. The method of claim 2, further comprising evaluating the sanitization record of the selected craft.

4. The method of claim 1, wherein the step of mitigating exposure to the identified health related event further comprises reserving a seat on the craft, including evaluating the travel history of people assigned to the seats in the vicinity of the reserved seat to determine prior travel to the geographic area affected by the identified health related event, and finalizing the seat selection based upon the evaluation.

5. The method of claim 1, wherein the step of mitigating exposure to the identified health related event further comprises evaluating the supply chain for a source of food to be served on the craft.

6. The method of claim 1, wherein the step of identifying a geographic region affected by the health related event includes selecting a threshold limit to define the level of the health related event to affect travel arrangements.

7. The method of claim 1, further comprising receiving a notification of the identified health related event following reservation of the selected travel, and modifying the reservation to mitigate exposure to the identified health related event.

8. A system to facilitate management of travel comprising:
a processor in communication with a data storage medium;
a management tool in communication with the data storage medium, the tool comprising:
a selection module to select a source and destination for travel, including departure and arrival dates;
the selection module to select a mode of transportation to support the selected source and destination travel;
an identification module in communication with the selection module, the identification module to identify a geographic area affected by an identified health related event;
an evaluation module in communication with the selection and identification modules, the evaluation module to determine if at least one craft supporting the selected mode of transportation matches the identified geographic area affected by the identified health related event;
a manager in communication with the evaluation module, the manager to mitigate exposure to the identified health related event, including supporting a change to the selected mode of transportation if the transportation matches the identified geographic area affected by the identified health related event; and
a reservation to support the selected travel based upon evaluation of the mode of transportation and with the identified health related event.

9. The system of claim 8, further comprising the evaluation module to determine exposure of the craft to the identified health related event, including a review of the sanitization record of the craft.

10. The system of claim 8, further comprising the manager to reserve a seat on the craft, including the manager to evaluate the travel history of people assigned to the seats in the vicinity of the reserved seat to determine prior travel to the geographic area affected by the identified health related event, and to finalize the seat selection based upon the evaluation.

11. The system of claim 8, further comprising the manager to evaluate the supply chain for a source of food to be served on the craft.

12. The system of claim 8, wherein the identification modules employs a threshold limit to define the level of the health related event to affect travel arrangements.

13. The system of claim 8, further comprising a notification module in communication with the manager, the notification module to receive a notification of the identified health related event following reservation of the selected travel and to modify the reservation to mitigate exposure to the identified health related event.

14. An article configured to manage travel, the article comprising:
a computer readable storage medium in communication with computer program instructions to collect and evaluate travel related data, the instructions comprising:
selection of a source and a destination for travel, including departure and arrival dates;
selection of a mode of transportation to support the selected source and destination travel;
identification of a geographic area affected by a health related event;
evaluation of the selected mode of transportation, including instructions to determine if at least one craft supports the selected mode of transportation and matches the identified geographic area affected by the health related event;
mitigation of exposure to the health related event, including instructions to support a change to the selected mode of transportation if the transportation matches the identified geographic area affected by the health related event; and
a reservation to support the selected travel based upon evaluation of the mode of transportation and with the identified health related event.

15. The article of claim 14, wherein the evaluating instructions of the select mode of transportation further comprises evaluation of at least one recent destination port for the selected craft and determining exposure of the craft to the health related event, and evaluation of the sanitization record of the selected craft.

16. The article of claim 14, wherein the mitigation of exposure to the health related event further comprises instructions to reserve a seat on the craft, including evaluating the travel history of people assigned to the seats in the vicinity of the reserved seat to determine prior travel to the geographic area affected by the health related event, and finalizing the seat selection based upon the evaluation.

17. The article of claim 14, wherein the mitigation of exposure to the health related event further comprises evaluation of the supply chain for a source of food to be served on the craft.

18. The article of claim 14, wherein the geographic region identification affected by the health related event includes selection of a threshold limit to define the level of the health related event to affect travel arrangements.

19. The article of claim 14, further comprising a notification of the identified health related event following reservation of the selected travel, and modification of the reservation to mitigate exposure to the identified health related event.
